(19) United States
(12) Patent Application Publication
(10) Pub. No.: US 2026/0045073 A1
(43) Pub. Date: Feb. 12, 2026

(54) METHOD FOR GENERATING LEARNING FACIAL IMAGE DATASETS FOR TRAINING MODELS FOR VARIOUS FACE-RELATED TASKS WITH IMPROVED MODEL PERFORMANCE IN PROCESSING EXTREME VIEW IMAGES

(71) Applicant: VINAI ARTIFICIAL INTELLIGENCE APPLICATION AND RESEARCH JOINT STOCK COMPANY, Ha Noi (VN)

(72) Inventors: Tuan Trung Dao, Ha Noi (VN); Hong Duc Vu, Ha Noi (VN); Van Cuong Pham, Ha Noi (VN); Tuan Anh Tran, Ha Noi (VN); Hai Hung Bui, Ha Noi (VN)

(21) Appl. No.: 18/956,672

(22) Filed: Nov. 22, 2024

(30) Foreign Application Priority Data
Aug. 9, 2024 (VN) 1-2024-05989

(51) Int. Cl. G06V 10/778; G06V 10/77; G06V 20/40; G06V 40/16

(52) U.S. Cl. CPC G06V 10/7788; G06V 10/7715; G06V 20/46; G06V 40/168

(57) ABSTRACT

The present invention related to a method for generating learning facial image datasets for training models, wherein the learning dataset named Extreme Pose Face High-Quality Dataset (EFHQ), which includes a maximum of 450k high quality images of faces at extreme poses. To generate e such a massive dataset, the method utilizes a novel and meticulous dataset processing pipeline to curate two publicly available datasets, VFHQ and CelebV-HQ, which contain many high-resolution face videos captured in various settings. The generated dataset can complement existing datasets on various facial-related tasks, such as facial synthesis with 2D/3Daware GAN, diffusion-based text-to-image face generation, and face reenactment. A face recognition apparatus and a face generation apparatus also provided which comprising at least of a processor and a memory and models stored thereon, wherein the model is trained using the dataset generated by the method thereof.

### TECHNICAL FIELD

The invention relates to the technical field of face recognition and face synthesis technologies, particularly related to a method for generating a training dataset for training models which provides high-quality extreme-pose images to complement a wide range of face-related tasks.

### BACKGROUND

Firstly, standard large-scale facial datasets (or existing publicly available datasets such as VFHQ and CelebV-HQ) having plentiful images at near frontal views, lack images with extreme head poses, leading to the downgraded performance of deep learning models when dealing with profile or pitched faces and causing inferior performance of trained models on downstream tasks when dealing with extreme head poses. For instance, the trained 2D image generators and text-to-image ones often produce only near frontal faces, while the 3D face generators and face reenactment methods often show distorted outputs at profile views. The recently proposed dataset LPFF partially handles that issue by providing complementary images at extreme head poses for only 2D and 3D image generation tasks. To this end, an arised problem need to be solved is to address this gap by introducing a novel dataset enriched with high-quality extreme-pose images to complement a wide range of face-related tasks such as 2D and 3D image generation, text-to-image generation and face reenactment at extreme views, and face verification benchmark to better assess the quality of face recognition networks.

Secondly, in addressing the challenges of face recognition, particularly under conditions where subjects exhibit natural activities leading to significant head rotations and extreme poses, there is a critical need for enhanced model evaluation methodologies. The lack of benchmark datasets tailored to these scenarios significantly hampers the ability of developers to assess and refine model performance effectively. Similarly, in the domain of face synthesis, including 2D/3D-aware face synthesis and face reenactment, there's an existing of a substantial bias towards frontal face imagery. This bias arises from a shortage of high-quality datasets featuring profile views, resulting in models that struggle to generate or realistically render profile faces when challenged to do so. Consequently, there is an urgent demand for a profile-centric face dataset that can support various applications, from model training and evaluation to advanced synthesis techniques. Such a dataset would facilitate the development of more robust and versatile models and advance the state of the art in face recognition and synthesis technologies. Meanwhile, although many video-based datasets contain profile-view images suitable for the aforementioned needs, there is a notable deficiency in methods required for efficiently and reliably extracting these frames. This gap highlights the necessity for developing advanced extraction techniques and tools that can mine profile views from video sources with high precision and reliability, further enriching the datasets available for tackling the unique challenges presented by extreme pose variations in face recognition and synthesis.

### CITATION LIST

### Non-Patent Literature

1. Sergey BEZRYADIN, et al. Brightness calculation in digital image processing. International Symposium on Technologies for Digital Photo Fulfillment, 2007:10-15, 2007. 4, 1.
2. Eric R. CHAN, et al. Efficient geometry-aware 3D generative adversarial networks. In CVPR, 2022. 1, 2, 4, 6.
3. Jiankang DENG, et al. Additive angular margin loss for deep face recognition. In Proceedings of the IEEE/CVF conference on computer vision and pattern recognition, pages 4690-4699, 2019. 3, 5, 6, 7, 8, 1, 2.
4. Tero KARRAS, et al. Analyzing and improving the image quality of stylegan. In Proceedings of the IEEE/CVF conference on computer vision and pattern recognition, pages 8110-8119, 2020. 4.
5. Harold W KUHN. The hungarian method for the assignment problem. Naval research logistics quarterly, 2 (1-2): 83-97, 1955. 3.
6. Sefik Ilkin SERENGIL et al., Lightface: A hybrid deep face recognition framework. In 2020 Innovations in Intelligent Systems and Applications Conference (ASYU), pages 23-27. IEEE, 2020. 3.
7. Sefik Ilkin SERENGIL et al., Hyperextended lightface: A facial attribute analysis framework. In 2021 International Conference on Engineering and Emerging Technologies (ICEET), pages 1-4. IEEE, 2021. 4.

### SUMMARY

Therefore, according to an aspect, provided are a method for generating learning facial image datasets for training models, a face recognition apparatus, face generation apparatus comprising models that is trained based on the dataset generated by the method thereof.

According to the first aspect, a method for generating a learning facial dataset for training models for various face-related tasks with improved model performance in processing extreme views, comprising: a step of acquiring source facial video data from publicly standard facial dataset which contain high-resolution face videos captured in various settings; a step of extracting multiple facial frames from the acquired facial video data to obtain a first facial dataset; a step of extracting facial attributes of each facial frame from the first facial dataset, wherein the extracted attributes comprising at least one or any combination of the following attributes: face bounding box, facial landmarks, image quality score, face identity and head pose angle; a step of manually reviewing each of the multiple facial frames of the first facial dataset with its extracted attributes for verifying head pose binning annotation to obtain a second facial dataset which is enhanced with complemented facial attributes annotations; a step of generating a complementary facial dataset from the second facial dataset, wherein the supplementary facial dataset comprising multiple frames with extreme head pose angle; a step of generating the learning dataset, by combining an original facial dataset of downstream task and the supplementary dataset, for training models.

In the first embodiment of the first aspect, the method for generating a learning facial dataset according to the first aspect, wherein the publicly standard facial dataset comprising one of the following VFHQ (Video Face High Quality) dataset and CelebV-HQ (High-Quality Celebrity Video) dataset or a combination thereof.

In the second embodiment of the first aspect, the method for generating learning facial image dataset for training models, wherein the step of extracting facial bounding box and facial landmark attributes is performed by the combination of at least three facial attributes detection models: RetinaFace, SynergyNet, HyperIQA.

In the third embodiment of the first aspect, wherein the step of extracting head pose angle attribute is performed by using a combination of at least three head pose estimators comprising SynergyNet, DirectMHP, FacePoseNet.

In the fourth embodiment of the first aspect, the method for generating learning facial image dataset for training models, wherein the step of extracting head pose angle attribute further comprising a step categorizing each estimated head pose into a hierarchical pose binning scheme, wherein the pose binning scheme comprising the following poses: profile_extreme, profile_horizontal, profile_vertical, frontal, profile_left, profile_right, profile_up, profile_down, wherein the poses are defined by related yaw and pitch angle.

In the fifth embodiment of the first aspect, the method for generating learning facial image dataset for training models, wherein the step of manual reviewing the extracted attributes is performed by using a graphical user interface tool to streamline the review process.

In the sixth embodiment of the first aspect, the method for generating learning facial image dataset for training models, wherein the complementary comprising up to 450 k frames with extreme head poses extracted from approximately 5,000 clips, wherein most of the clips in the source facial video data including at least one frame with a frontal face and multiple frames with extreme head pose angles.

In the seventh embodiment of the first aspect, the method for generating learning facial image dataset for training models, wherein the trained model is applied for multiple face-related technique such as 2D and 3D image generation, text-to-image generation, face reenactment and face recognition.

According to the second aspect, a face recognition apparatus comprising at least of a processor and a memory and models stored thereon, wherein the model is trained using the dataset generated by the method of above mentioned methods of the first aspect and embodiments of the first aspect.

According to the third aspect, a face generation apparatus comprising at least of a processor and a memory and models stored thereon, wherein the model is trained using the dataset generated by the method of above mentioned methods of the first aspect and embodiments of the first aspect.

### BRIEF DESCRIPTION OF THE DRAWINGS

FIG. 1 is a functional block diagram illustrating learning facial image datasets generation method for training models according to an embodiment.

FIG. 2 is a chart illustrating the pose distribution comparison between our sampled dataset and other datasets, including FFHQ, LPFF, CPLFW and 40 K random samples from VoxCeleb1.

FIG. 3 illustrating example cases where a pose estimator fails to categorize the sample to the correct bin while the combination of three pose estimations provides the correct one.

FIG. 4 illustrating faces synthesized by 3D face generation or face reenactment models are often distorted at profile views, due to the scarcity of extreme pose images in training datasets 3D face generation or face reenactment models are often distorted at profile views.

FIG. 5 illustrating the qualitative result and comparison of generated samples, with truncation v=0.7, from StyleGAN2-ADA training with other dataset and dataset generated by the method of the invention.

FIG. 6 illustrating the comparison between multiview generated samples, with truncation v=0.8, of EG3D models trained with various datasets.

FIG. 7 illustrating the comparison profile-view generated samples of pretrained ControlNet (left) and our fine-tuned ControlNet (right) with the prompt: “A profile portrait image of a person”.

FIG. 8 illustrating the comparison of performance for frontal-profile face reenactment on EFHQ. From left to right: source image, TPS on VoxCeleb1, TPS with EFHQ, LIA on VoxCeleb1, LIA with EFHQ, driving image. Additional EFHQ training data improves synthesis of extreme poses.

FIG. 9 illustrating the representative examples of the raw LPFF dataset that got excluded from the final dataset, either from misdetections or pose filtering process.

### DETAILED DESCRIPTION OF THE INVENTION

Hereinafter, an embodiment according to an aspect (hereinafter, referred to as “an embodiment”) will be described based on the drawings. Note that constituent elements having the same or similar configurations are denoted by the same reference signs.

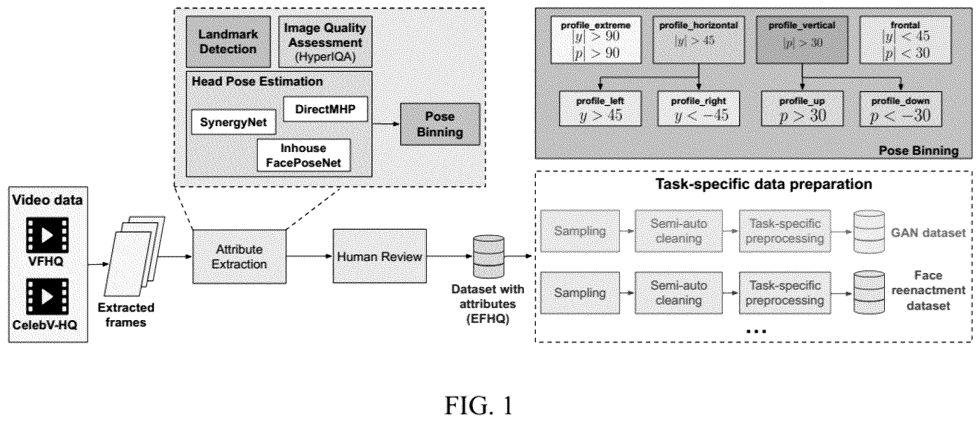

As shown in FIG. 1, the pipeline of EFHQ dataset generation method starting with high-quality videos from the VFHQ and CelebV-HQ datasets, single-frame attributes are extracted then manually reviews. Task-specific preprocessing is then applied to generate specialized versions of the dataset for tasks such as face generation, reenactment, and verification. To fulfill these goals, the method comprising a step of curating frames from the two recent facial video datasets, VFHQ and CelebV-HQ, as seen in FIG. 1.

The method illustrated in FIG. 1 comprising the Attributes Extraction step. Detailed operation of the Attribution Extraction step is now described as follows. In order to curate accurate facial poses and high-quality frames from existing datasets, firstly extracting the following attributes: (1) face bounding boxes, (2) facial landmarks (5/68keypoints), (3) image quality score, and (4) face identity.

For bounding boxes and landmarks, popular RetinaFace and/or SynergyNct can be employed. The method further uses HyperIQA to score image quality. For VFHQ, the method only generates 68 landmarks and image quality scores since bounding boxes and 5 keypoints are provided. After extracting these attributes, the step of matching these attributes with existing annotations using an IoU-based Hungarian matching algorithm [5]. Regarding identity, VFHQ-wise, we source labels from the annotations. As CelebV-HQ lacks individual identity labels within the video, a solution disclosed in reference document [6] can be used to identify the identities associated with each bounding box.

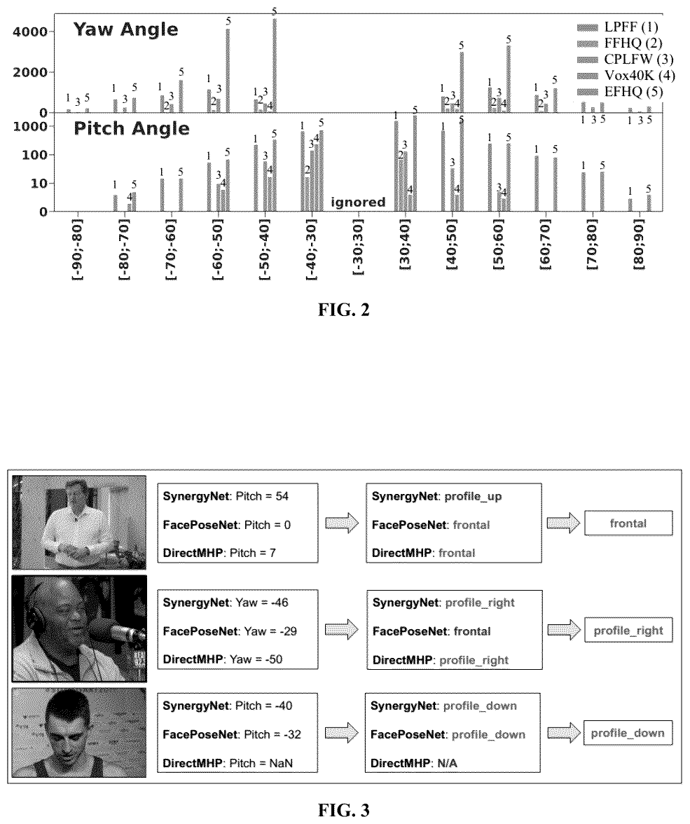

Due to the instability of head pose estimators when handling extreme-pose images, the method strategically applies multiple pose estimators relying on various state of the art techniques including: (1) SynergyNet, a 3DMM-based model, (2) DirectMHP, a landmark-free joint head detector and pose estimator, and (3) an in-house FacePoseNet improved through extensive data augmentation focused on extreme poses and extra training data. The method then categorizes each estimated pose into a hierarchical binning scheme illustrated in FIG. 1. Next, the method gathers bin predictions and perform majority voting to arrive at consensus labels. When no agreement emerges, we put it into the 5th bin for “confusing” cases. As depicted in FIG. 3, this ensemble approach provides robustness in cases where a single estimator incorrectly categorizes a sample. Please refer to the supplementary for statistics of the extracted bins and the hyperparameters for each model used for attribute extraction.

According to FIG. 1, the dataset generation method further comprising a step of Annotation Review by manually reviewing the results to ensure high-quality labels. Given the large dataset, we developed a graphical user interface tool to streamline the review process. Our focus is verifying the binning annotations, which most directly impact label accuracy. Finally, EFHQ datasets are generated by randomly subsampling the data based on pose angle and image quality to validate facial landmark quality further and discard cases of landmark prediction failure.

According to FIG. 2, the final EFHQ dataset comprises up to 450 k frames with extreme poses extracted from approximately 5,000 clips. Most of the clips in our dataset include at least one frame with a frontal face and multiple frames with extreme pose angles. The method also includes extreme pose-only clips, representing profile-to-profile pose transfer cases.

According the other embodiment, datasets for subtasks are generated for face's related tasks adaptation.

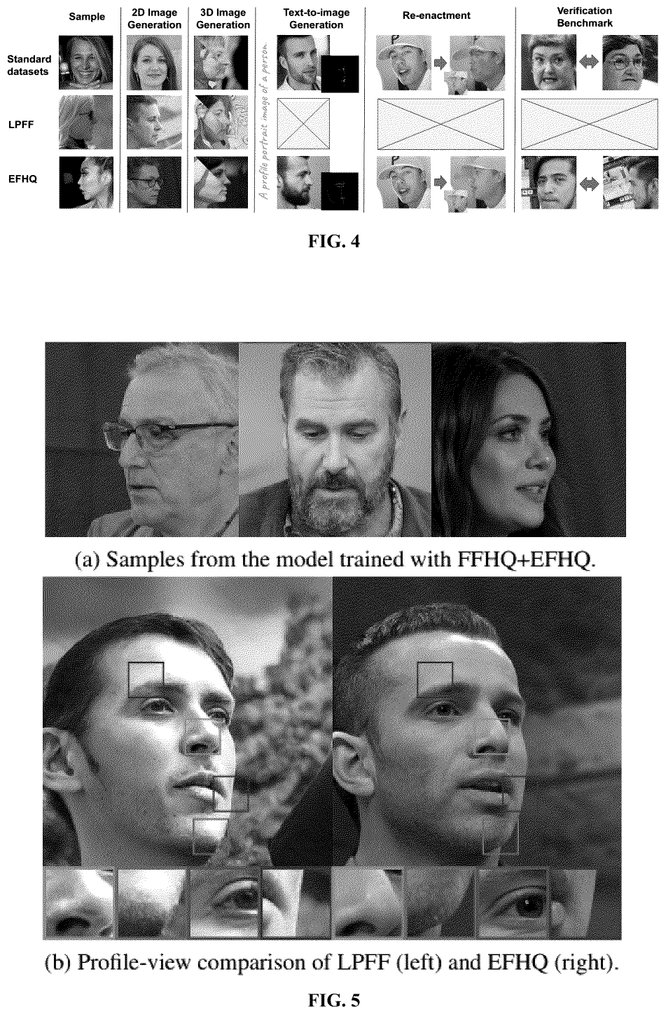

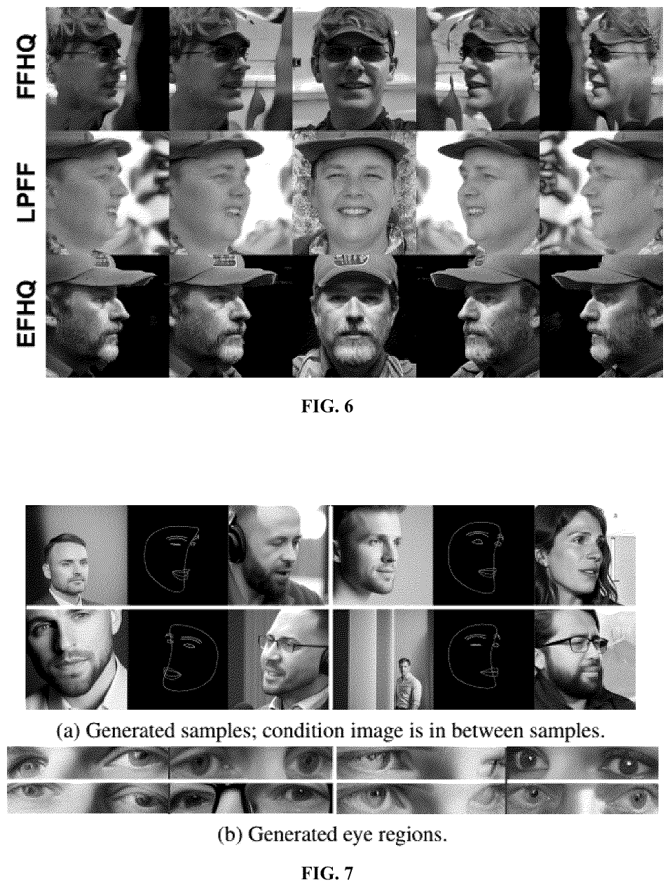

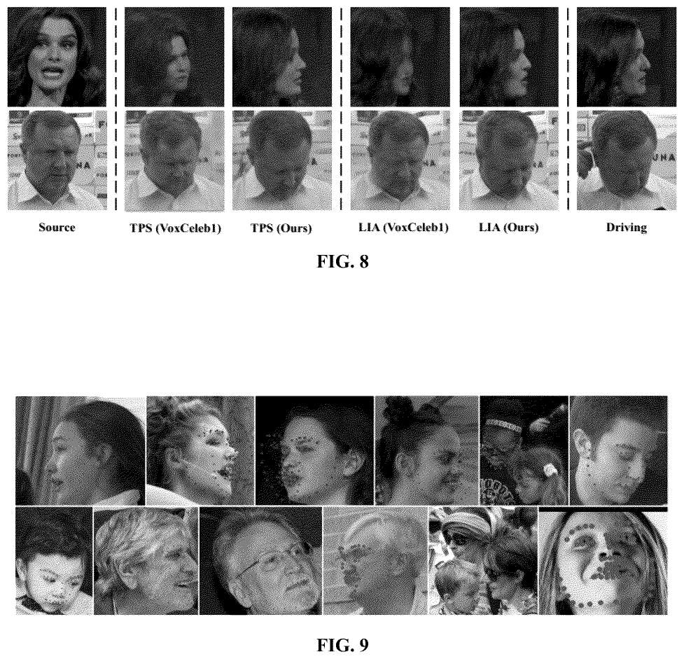

For example, for face generation task, a supplementary dataset for face generation application is added to existing dataset for training models for face recognition. To address FFHQ's pose distribution gap, we compile a dataset encompassing diverse poses, varied identities, and FFHQcomparable image quality from EFHQ. Additionally, we also embed an image brightness filter [1] in the sampling process, given that HyperIQA doesn't explicitly assess this aspect. The sampled images are then processed using the same pipeline in [2, 4] and manually reviewed. The aim is to improve coverage of under-represented poses without degrading frontal performance of trained generation models. This yields a dataset of 42,671 images with equitably distributed poses as visualized in FIG. 4. Compared to the original FFHQ distribution, yaw and pitch distributions are significantly improved. Additionally, for 3D-aware GAN subtasks, we extract camera parameters to serve as conditional pose information, following [2]. We convert these parameters into yaw, pitch angles to validate against our existing annotations. When disagreements emerge, we re-examine the images and filter if needed, to ensure accurate, quality labels. For diffusion-based text-to-image generation, a specialized dataset is curated to refine Stable Diffusion models by accommodating landmark conditional input through ControlNet. Based on our 3D-aware face generation dataset, we integrate landmark-based conditional images and tailored text prompts for each image. To capture fine facial nuances, we extract 478 facial landmarks and draw the condition image with connected edges between matched keypoints, following Mediapipe framework, better conveying face expression and pose. For text prompts, detailed facial attributes like gender, race, and emotion are derived from existing labels or inferred via BLIP-2 pretrained captioning model and a face attribute estimator [7]. The resulting prompt adheres to a structured format: “A profile portrait image of a [emotion] [race] [gender].”

TABLE 2
StyleGAN2-ADA models trained on different datasets.

| Model | Reference Dataset | FID↓ | Recall↑ |
|---|---|---|---|
| [symbol] | FFHQ | 2.84 | 0.49 |
| [symbol] | FFHQ + LPFF | 3.43 | 0.44 |
| [symbol] | FFHQ + EF HQ | 3.44 | 0.46 |
| [symbol] | FFHQ + EFHQ | 8.26 | 0.43 |
| [symbol] | FFHQ + LPFF | 7.04 | 0.44 |
| [symbol] | FFHQ + EFHQ | 3.33 | 0.46 |
| [symbol] | FFHQ | 3.12 | 0.44 |
| [symbol] | FFHQ + LPFF | 4.47 | 0.42 |

Lower FIDs indicate better fidelity, while higher Recalls indicate better diversity. The second and third blocks show comsparisons between unconditional models trained on FFHQ + LPFF and FFHQ + EFHQ when evaluating on the same and cross-dataset settings, with the better metrics in bold. [symbol]
indicates data missing or illegible when filed

As illustrating in FIG. 2, StyleGAN2-ADA model trained on different datasets.

Lower FIDs indicate better fidelity, while higher Recalls indicate better diversity. The second and third blocks show comparisons between unconditional models trained on FFHQ+LPFF and FFHQ+EFHQ when evaluating on the same and cross-dataset settings, with the better metrics in bold.

The method further generating Supplementary dataset for face reenactment. As EFHQ is crafted, we can employ the entire dataset to complement established training datasets, e.g., VoxCeleb1. We also built an extra evaluation set with 1200 EFHQ clips. Benchmarking dataset for face verification. We curate a dataset covering three distinct scenarios: frontal-to-frontal, frontal-to-profile, and profile-to-profile. To enable rigorous benchmarking, we sample 10,000 pairs each for both negative and positive cases per scenario, resulting in a balanced benchmark dataset containing 60,000 image pairs. Images follow the same established preprocessing pipelines in [3]. Next, we filter misaligned images with RetinaFace, randomly review, and replace equivalent samples from our diverse corpus, if needed. Finally, to simulate varying image quality, we randomly applied downscaling and compression to samples in the dataset.

The method further generating Benchmarking dataset for face verification. We curate a dataset covering three distinct scenarios: frontal-to-frontal, frontal-to-profile, and profile-to-profile. To enable rigorous benchmarking, we sample 10,000 pairs each for both negative and positive cases per scenario, resulting in a balanced benchmark dataset containing 60,000 image pairs. Images follow the same established preprocessing pipelines in [3]. Next, we filter misaligned images with RetinaFace, randomly review, and replace equivalent samples from our diverse corpus, if needed. Finally, to simulate varying image quality, we randomly applied downscaling and compression to samples in the dataset.

According to the second aspect, a face recognition apparatus comprising at least of a processor and a memory and models stored thereon, wherein the model is trained using the dataset generated by the method of above mentioned methods of the first aspect and embodiments of the first aspect.

According to the third aspect, a face generation apparatus comprising at least of a processor and a memory and models stored thereon, wherein the model is trained using the dataset generated by the method of above mentioned methods of the first aspect and embodiments of the first aspect.

### Technical Effect of Present Invention

This work has introduced a large-scale, diverse facial dataset to address performance gaps between frontal and profile faces, powered by a novel and robust data processing pipeline. Crucially, we provided tailored sub-datasets for advancing essential tasks like face synthesis and reenactment. Moreover, our new face verification benchmark reveals gaps between techniques, granting valuable insights. Ultimately, we hope this high-quality, diverse facial dataset opens up new and exciting opportunities to push forward cross-pose tasks.

1. A method for generating a learning facial dataset for training models for various face-related tasks with improved model performance in processing extreme views, comprising:
a step of acquiring source facial video data from publicly standard facial datasets which contain high-resolution face videos captured in various settings;
a step of extracting multiple facial frames from the acquired facial video data to obtain a first facial dataset;
a step of extracting facial attributes of each facial frame from the first facial dataset, wherein the extracted attributes comprising at least one or any combination of the following attributes: face bounding box, facial landmarks, image quality score, face identity and head pose angle;
a step of manually reviewing each of the multiple facial frames of the first facial dataset with its extracted attributes for verifying head pose binning annotation to obtain a second facial dataset which is enhanced with complemented facial attributes annotations;
a step of generating a supplementary facial dataset from the second facial dataset, wherein the complementary facial dataset comprising multiple frames with extreme head pose angle; and
a step of generating the learning dataset for downstream tasks, by combining an original facial dataset of downstream task and the supplementary dataset, for training models.

2. The method for generating a learning facial dataset according to claim 1, wherein the publicly standard facial dataset comprising one of the following VFHQ (Video Face High Quality) dataset and CelebV-HQ (High-Quality Celebrity Video) dataset or a combination thereof.

3. The method for generating a learning facial dataset according to claim 2, wherein the step of extracting facial bounding box and facial landmark attributes is performed by the combination of at least three facial attributes detection models: RetinaFace, SynergyNet, HyperIQA.

4. The method for generating a learning facial dataset according to claim 3, wherein the step of extracting head pose angle attribute is performed by using a combination of at least three head pose estimators comprising SynergyNet, DirectMHP, FacePoseNet.

5. The method for generating a learning facial dataset according to claim 4, wherein the step of extracting head pose angle attribute further comprising a step categorizing each estimated head pose into a hierarchical pose binning scheme, wherein the pose binning scheme comprising the following poses: profile_extreme, profile_horizontal, profile_vertical, frontal, profile_left, profile_right, profile_up, profile_down, wherein the poses are defined by related yaw and pitch angle.

6. The method for generating a learning facial dataset according to claim 5, wherein the step of manual reviewing the extracted attributes is performed by using a graphical user interface tool to streamline the review process.

7. The method for generating a learning facial dataset according to claim 6, wherein the complementary comprising up to 450 k frames with extreme head poses extracted from approximately 5,000 clips, wherein most of the clips in the source facial video data including at least one frame with a frontal face and multiple frames with extreme head pose angles.

8. The method for generating a learning facial dataset according to claim 7, wherein the trained model is applied for multiple face-related technique such as 2D and 3D image generation, text-to-image generation, face reenactment and face recognition.

9. A face recognition apparatus comprising at least of a processor and a memory and models stored thereon, wherein the model is trained using the dataset generated by the method of claim 1 for face recognition.

10. A face generation apparatus comprising at least of a processor and a memory and models stored thereon, wherein the model is trained using the dataset generated by the method of claim 1 for face generation.
